(19) United States
(12) Patent Application Publication
(10) Pub. No.: US 2009/0101310 A1
(43) Pub. Date: Apr. 23, 2009

(54) Articulated Joint with Adjustable Stiffness

(75) Inventor: Mogens Juhl Fons, Faarup (DK)

Correspondence Address: JAMES C. WRAY, 1493 CHAIN BRIDGE ROAD, SUITE 300, MCLEAN, VA, 22101, US

(73) Assignee: FØNS TECHNOLOGY ApS, Faarup (DK)

(21) Appl. No.: 11/920,178

(22) PCT Filed: May 8, 2006
(86) PCT No.: PCT/DK2006/000247

§ 371 Date: Nov. 30, 2007

(30) Foreign Application Priority Data
May 10, 2005 (DK) PA 2005 00673

(51) Int. Cl. F28C 3/16; F28F 27/02; F27D 15/02

(52) U.S. Cl. 165/104.16; 165/153; 165/174; 432/77

(57) ABSTRACT

A bed of particulate material 6 is supported by an air distribution bottom 5. Under the distribution bottom 5 exist one or more compartments 7, which each being supplied with cooling air from a fan installation 8. The distribution bottom 5 is sectionalised in a number of smaller areas 9. Each smaller distribution area 9 is connected to the compartment 7 by ducts 10, 11 and 12. The one duct 10 does have a fixed orifice area. The ducts 11 and 12 do have floaters 13A/13B end stop 14A/14B and bottom support 15A/15B. It is hereby obtained that the total pressure loss across the air distribution bottom can be reduced, and so that the flow of the treatment air through the material bed is distributed in a desirable manner across the entire air distribution bottom regardless of the composition of the material bed and the distribution thereon, and optimal heat exchange efficiency is obtained.

### FIELD OF THE INVENTION

The present invention relates to a method for cooling a bed of particulate material which is supported by air which via ducts is conducted in sectionalised manner to and directed up through the air distribution bottom and the bed of material from one or several underlying compartments, while the particulate material is transported horizontally from the inlet end to the outlet end of the distribution bottom.

The invention relates also to an air flow device for carrying out the method according to the invention.

### BACKGROUND OF THE INVENTION

An example of a device which comprises of an air distribution bottom, is a cooler for cooling, for example cement clinker. In such a cooler the primary aim is to achieve a favourable degree of heat exchange between the clinker and the cooling air so that a substantial part of the thermal energy contained in the hot clinker can be returned to the kiln system in the cooling air, while, at the same time, the clinker is discharged from the cooler at a temperature which is very close to the ambient temperature. It is a precondition for achieving a favourable degree of heat exchange that the cooling air flow through the clinker is well-defined.

In connection with the cooling of cement clinker which is discharged from the kiln installed ahead of the cooler it has, however, emerged that the clinker is not always uniformly distributed across the width of the cooler. Instead, there is a tendency towards the clinker being distributed so that the larger clinker lumps are predominantly located at the one side of the cooler, whereas the fine clinker lumps are located at the other side. Also, the thickness of the clinker bed may exhibit variations both longitudinally and transversely through the cooler. Since it is easier for the cooling air to penetrate a bed of larger clinker lumps and/or a thinner bed as compared to penetrating a bed of finer clinker lumps and/or a thicker bed, and since, quite naturally, the cooling air will always follow the route of least resistance, any such uneven distribution of clinker often entails that the finer clinker material is not sufficiently cooled, hence causing hot zones, so-called “red rivers”, to be formed in the cooler. Such uneven distribution of the clinker will also entail that the cooling air in the areas where it encounters least resistance will simply cool the clinker more, due to the higher air flow through the clinker bed in the area.

When air is heated and if the pressure is maintained, it will expand following the laws of thermodynamic.

When an area does have a thinner clinker bed, as described above it becomes an attractive way for the air to flow through. After cooling the clinker to a higher degree compared to the clinker in the thicker surroundings, the following air travelling through will not be heated to the same level, due to the cooler clinker, and therefore the air will not expand. The non expansion will result in a lower pressure drop when passing the clinker bed, which again will lead to even more cold air passing through specifically in this area. The instability in the cooling process by having air, which is a compressive media, passing the clinker bed is apparently inevitable. The result of this instability is also causing a reduced heat exchange effect.

The heat exchange efficiency of the cooler is essential for having the highest possible air temperature returning to the process, after heat exchanging with the clinker.

Since the whole kiln system over the last three decades have become more and more efficient regarding fuel consumption, the required air amount to burn this fuel amount has decreased also. With a decreased air amount, for the same clinker amount, the demand for the high heat exchange efficiency has increased. In the 1980's the sizes of the areas of the orifice in the air distribution bottom areas were increased. This resulted in a stiffer air distribution in the whole air distribution bottom, and hereby the flow differences within the whole air distribution bottom were not influenced to the same degree by any pressure differences in the clinker layer. But this resulted in a higher compartment pressure, due to the higher pressure difference across the orifices. Hereby the fans supplying the air to the compartments will consume more electricity.

In PCT/US96/02971 a mechanical flow regulator is patented, where a continuous regulation of each flow regulator is automatically moveable in direct response to the air flow condition.

For ideal cooling of the clinker bed with a uniform clinker size, the pressure loss through the clinker bed is proportional to the clinker bed height and to the square of the air flow, due to the fact that turbulent flow occurs within the clinker bed.

The flow should be locally reduced when a lower clinker bed has occurred.

In PCT/US96/02971 it is mentioned that besides a constant flow—also to have the possibility of a decreasing flow when having and increased pressure resistance across the device, which should correspond to a decrease in flow resistance across the clinker bed. Nevertheless this results in instability of the operation of the whole cooler/kiln system, and therefore it is not realizable.

The fans are normally supplying a constant total air flow to each cooler compartment where the air, after heat exchanging with the clinker, supply the burners with a constant air flow to obtain a stable kiln operation.

If the flow devises did have the reduced flow characteristics to ensure the better heat exchange efficiency, the following would occur: Imagine a thinner clinker bed in one area. The devises would reduce the flow in this area, but with a constant flow from the fan, this would result in a higher pressure in the whole compartment, and hereby more air would pass the bed in the before mentioned area, the device would close even more, which would results in higher pressure in the compartment. Other devises will now start to close, and finally all devises would close and the fan, if not already stalled, would just work through fixed small orifices. Hereby the whole idea of the flow control devise is out of function and the cooler works by the old principles of just having small fixed orifices to every part of the air distribution bottom.

In the German Patent 1221984 from 1965 an on/off device is patented for fluid beds and spouted beds. The device is of an on/off type to collapse a blow through of air in the above fluid or spouted bed.

The patent 1221984 also mentions that the on/off device does not have to fully close the supply duct. This is due to the fact that after a blow through of the fluid or spouted bed the device will close—but even with a small amount of air in the remaining opening, the fluid or spouted bed will still collapse. Hereafter the device will leave its closed position, and the fluid or spouted bed will again have the full air flow through the bed in this position.

The spouted and fluid bed does have very different nature from the clinker bed, due to the fact that they can be looked upon as fluid. A clinker bed would not operate satisfactory with the on/off devices from patent 1221984, due to the same chain reaction as described above with a decreased flow characteristic at a decreased bed flow resistance—Patent PCT/US96/02971. With other words all on/off devices would finally close and no heat exchange benefit regarding flow compensation would have been obtained.

The present invention will obtain a more optimal heat exchange efficiency that was not reachable before with Patent PCT/US96/02971, without having the negative chain reaction described before. The invention relates to a bed of non fluid characteristics.

### OBJECT OF THE INVENTION

The invention addresses these objects by providing an air flow control device which is particular in that the device comprises a base plate suitable for being mounted in a floor, wall, ceiling or other partition, where the base plate has a front side adapted to be arranged towards the material to which the airflow is directed, and a back side opposite the front side, and that in said base plate, two or more apertures are provided, where at least one aperture is in the shape of a cylinder having the cylindrical axis not parallel to the plane of the base plate, and that inside said cylinder radial restriction means are arranged adjacent both open ends of the cylinder, and that a float member is provided between said radial restrictors, where when the float member is in contact with the upper radial restrictor arranged adjacent the front side of the base plate, flow through the cylinder is cut off.

By providing at least two apertures in the base plate which will be incorporated in a cooling floor the device in the use situation provides for a certain minimum air supply through the not-restricted aperture and a controlled air flow with a float member which will regulate the air flow through the second aperture, such that the air flow through the air flow control device will be variable within predetermined limits. These limits will be decided according to the amount of particulate material, i.e. the thickness of the layer above the air flow control device such that variations in the particulate layer thickness will change the air pressure and in particular the air pressure drop, across the particulate layer such that the float member will be activated either in order to limit the amount of cooling air or to increase the amount of cooling air.

The cylinder radial restriction means at the bottom of the cylinder serves to avoid that the float member falls out of the cylinder which could be the situation when a very dense layer of particulate material needs to be cooled in that the low air resistance through a thin particulate layer will create the situation where only a very limited amount of cooling air is needed. The radial restriction means at the top of the cylinder serves to limit the upward movement of the float member and at the same time create a gasket seat such that, as the float member engages the uppermost radial restriction means the air stream through the cylinder is discontinued.

In a further advantageous embodiment this is further improved in that two or three cylinders are provided where they all have either different cross-sectional areas, or where the weight of the float members are different, such that the flow through the airflow control device, will cause one or more float members to engage the upper radial restrictors.

Cylinders are generally defined as geometrical bodies having parallel sides, i.e sides parallel to a common axis, but tests have indicated that also slightly conical “cylinders”, i.e. where the sides are not parallel, i.e deviate a few degrees from the common axis does fulfil the objectives of the present invention.

By adjusting the weight of the float members or the cross sectional areas of the cylinders the apertures containing float members will close at different air pressure levels. This provides for a better adjustment, i.e. that the air flow control device will be able to regulate the air flow through the particulate bed, more precisely and in a better response to the thickness and the density of the particulate bed material such that an improved cooling/heat exchange will take place in relationship to the amount of ventilation air.

In a still further advantageous embodiment, one aperture is not provided with float members and the cross sectional area of this aperture may be varied. This open aperture will as already mentioned above guarantee a minimum ventilation flow through the particulate bed material and by being able to adjust the cross section area of this opening it is possible to determine certain overall intervals which the air flow control device will be able to operate in, when the not obstructed aperture is working in conjunction with the cylinders containing float members.

In a further advantageous embodiment of the invention each cylinder having a float member has a cross-sectional area corresponding to 15% or less, more preferred 10% or less of the entire air flow area of the device.

Within the scope of this application cross sectional areas of orifices or apertures are to be understood as effective flow areas. The cylinders or apertures may have a cross sectional area, but where float members are present the effective area is the area of the cylinder minus the area of the float member in that particular cross section.

In this manner each air flow control device has a substantially constant air flow through the flow control device, but the float members aide and regulate a constant and optimal air flow when the cross sectional areas only represent a minor part of the entire cross sectional open area.

In order to provide further adjustment possibilities, the invention in a further advantageous embodiment may be provided with a hood, covering a substantial part of the front side of the base plate, where said hood is pivotably connected to the base plate, such that an adjustable gap is provided between the front side of the base plate and the rim of the hood. The hood and the pivotal mounting of the hood creates a ventilation gap between the hood and the base plate such that the hood and especially the adjustment of the gap will serve as an overriding air flow resistance component. The air flow control devices may be adjusted in use, such that an even distribution of the entire ventilation air led to the compartment under the particulate bed due to the provision of the hoods may have a coarse adjustment of the ventilation air across the entire cooling area. By furthermore adjusting the size of the apertures not having float members, each individual air flow control device may be adjusted in relation to a neighbouring float device such that the distribution of ventilation air is further improved and finally by adjusting the air flow through the float members and the weight of the float members a very precise adjustment of the entire air flow across the cooling bed of particulate material may be designed and adjusted whereby optimal cooling is achieved.

The invention also relates to a method for cooling a bed of particulate material as described in further advantageous embodiments.

### DESCRIPTION OF THE DRAWING

The invention will now be explained with reference to the accompanying drawing wherein

FIG. 1 illustrates a cooler;

FIG. 2 illustrates a cross section through the ventilation device incorporated in the cooler's floor;

FIG. 3 which is a three dimensional illustration of the detail of FIG. 2;

FIG. 4 is a cross section through an air flow control device;

FIG. 5 is the underside of an air flow control device;

FIG. 6 is a graphical representation of different flow settings;

FIGS. 7, 8 and 9 are different settings for the air flow control device.

### DESCRIPTION OF THE INVENTION

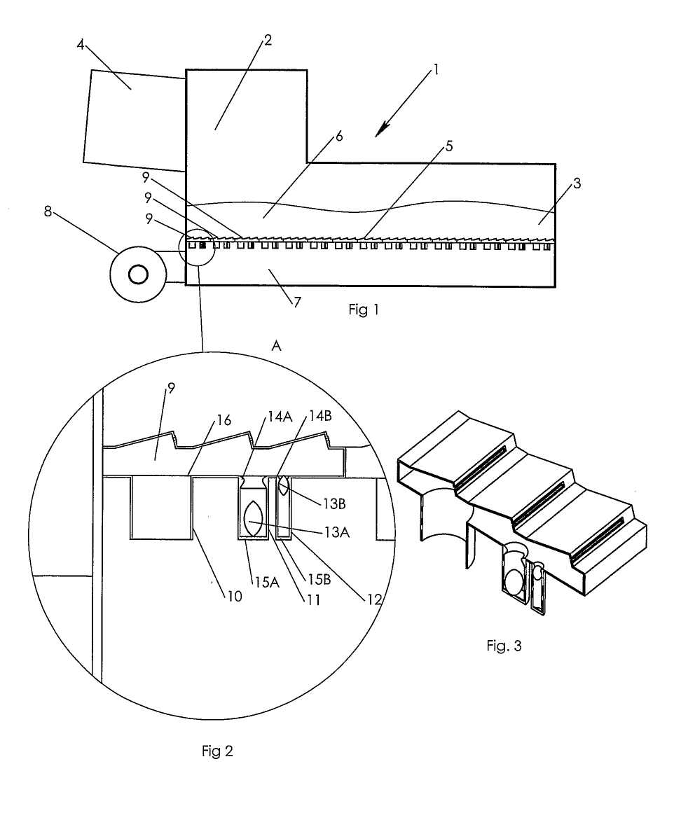

In FIG. 1 is shown a cooler 1 which comprises an inlet end 2 and an outlet end 3. The cooler is connected to a rotary kiln 4 from which it receives hot material which is to be cooled. The material from the rotary kiln drops onto a distribution bottom 5 provided in the cooler 1 and it is conveyed as a material layer 6 on the distribution bottom 5 from the inlet end 2 to the outlet end 3 of the cooler 1 by means of transport—not shown. The means of transport could, not limited to, be: reciprocating grates, reciprocating bars or a walking floor principle. Under the distribution bottom 5 the cooler 1 comprises of one or more compartments 7, where each is supplied with cooling air from a fan installation 8. The compartment 7 may both in the longitudinal direction of the cooler and transversely hereof, be divided into a number of smaller compartments, not shown, and, if so, cooling air is supplied to each single compartment. The distribution bottom 5 is sectionalised in a number of smaller distribution areas 9. Each smaller distribution area 9 is connected to the compartment 7 by ducts 10, 11 and 12, see FIG. 2. The one duct 10 does have a fixed orifice area. The ducts 11 and 12 do have floaters 13A/13B end stop 14A/14B and bottom support 15A/15B. Where the floater 13A is shown in the off position supported at 15B not restricting the air flow orifice area of duct 11, and where 13B is shown in the closed on position against 14B restriction the air flow orifice area of duct 12. FIG. 3 shows the same as FIG. 2 only in a three dimensional view—of cause the ducts are cut open to illustrate the floaters 13, the end stop 14 and the bottom support 15. The multiple numbers of floaters can work in individual ducts as shown or they could be probably guided in joint duct(s). Hereby having each floater reducing there part of the air flow orifice area when closing.

By introducing, in to every sectionalised area 9 of the bottom 5, in parallel with a fixed orifice 10 one on/off device (13,14 and 15), with relatively little delta pressure for on/off operation of 13A and relatively little open/close orifice areas 14A compared to the fixed orifice area 16, it is possible to obtain a better heat exchange efficiency, that if constant flow were supplied to each area, and still not risking the negative chain reaction regarding closing every devise in a compartment supplied by one fan 8.

When one device switches on, due to low flow resistance in the above clinker layer, the pressure in the compartment will increase a little, but the total picture will of cause be that the switched on device will supply less air flow to the clinker above it than the other sectionalised areas having devises not switches on. It is important that the normal delta pressure over the devices, when having a uniform clinker resistance and the design total airflow from the fan is present, is somewhat lower than the delta pressure that switches the devices on.

The heat exchange efficiency can be further improved by introducing multiple parallel on/off devices 13A/13B to each sectionalised area. In this case it is essential that the delta pressure for on/off operation is different for each on/off device within this one set of devices.

It is essential to have delta pressure, and hereby the cut-off flow and delta orifice area very different from that in shown in patent DE1221984 for fluid and spouted beds. In DE1221984 the flow, once the devise is switched on, is maybe some 20% of the total flow over the devise when not switched on. For the invention it is the other way around that the total orifice area drops from 100% to some 80% when activating one devise.

In practice typically one or more parallel sets of on/off devises will each when switched on reduce the total orifice area with less than 10%.

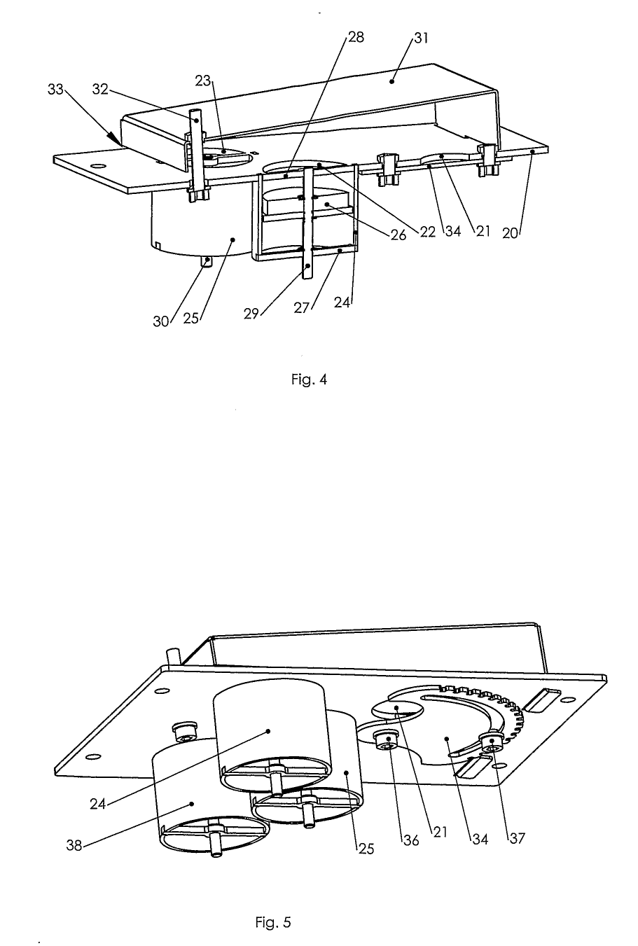

Turning to FIG. 4 a cross section through an air flow control device is illustrated. In the base plate 20 is provided a number of apertures 21, 22, 23. The first aperture 21 is simply a hole through the base plate whereas in connection with the apertures 22, 23 cylinders 24, 25 are provided. The cylinders or at least the apertures 22, 23 have different sizes such that the float members of which one 26 is illustrated in cross section may move up and down inside the cylinders 24, 25 in response to the air flow indicated by the arrow A. In the cylinder is furthermore provided radius restriction means 27, 28. The lower radius restriction means 27 serves to maintain the float member 26 inside the cylinder should there be no air flow A through the device. In the situation where the air flow A is so slow that the weight of the float member 26 overcomes the air flow, the float member 26 will move towards the lower radius restriction means 27. In situations where the air flow A is increased the air flow will cause the float member to move upwards against the upper radius restriction means 28 which at the same time is designed as a gasket seat for the float member such that the air flow through the aperture 22 is cut off.

In the particular embodiment the float members 26 are guided by axles 29, 30 in order to avoid that the float members 26 becomes stuck inside the cylinder and thereby causes the air flow control device not to respond properly to the required air flow.

A hood 31 is provided which hood substantially covers the entire top side of the base plate 20 such the all apertures 21, 22, 23 are contained inside the hood. The hood is pivotally mounted in one end and in the other end is provided with adjustment means 32 such that an air gap 33 may be adjusted between the base plate 20 and the hood 31. In this manner the hood 31 serves to be able to coarsely adjust the entire air flow through the air flow control device.

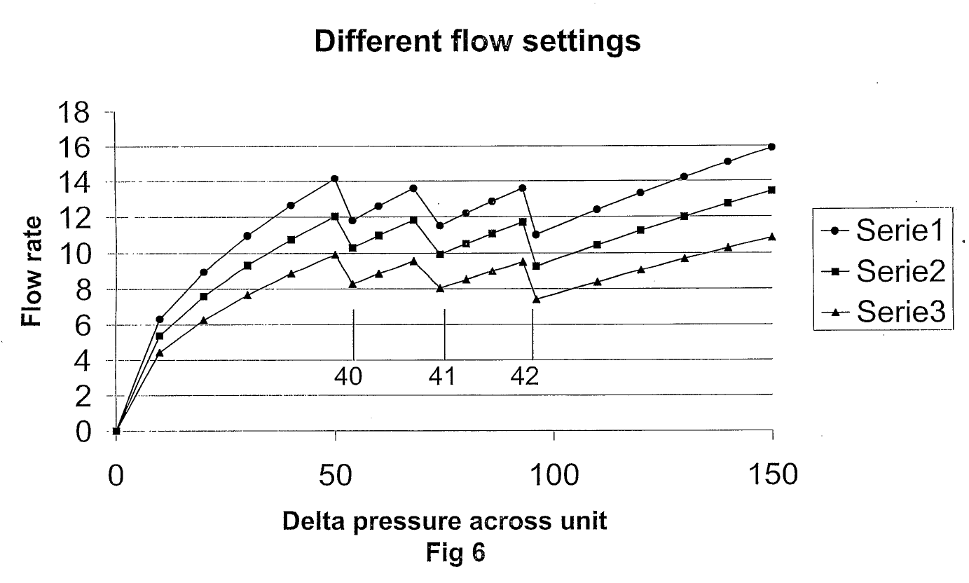

In practice when a number of air flow control devices are mounted in a cooler, each device will be pre-adjusted to a certain percentage ventilation effect, for example 80% in a central part of the cooler and perhaps 60% along the sides of the cooler. The pre-adjustment will be effected by adjusting the effective flow area through the free aperture 21. To this effect the base plate may be forseen with indications, such that the pre-adjustment is easily carried out. Thereafter the hood is adjusted such that the float member in the middle cylinder is floating on the airstream. In this position the characteristics will be such that the air flow control device will be substantially in the middle of the middle zig-zag, see FIG. 6 and explanation below.

Further an adjustment plate 34 for adjusting the cross sectional area of the aperture 21 is provided. This may better be seen in FIG. 5.

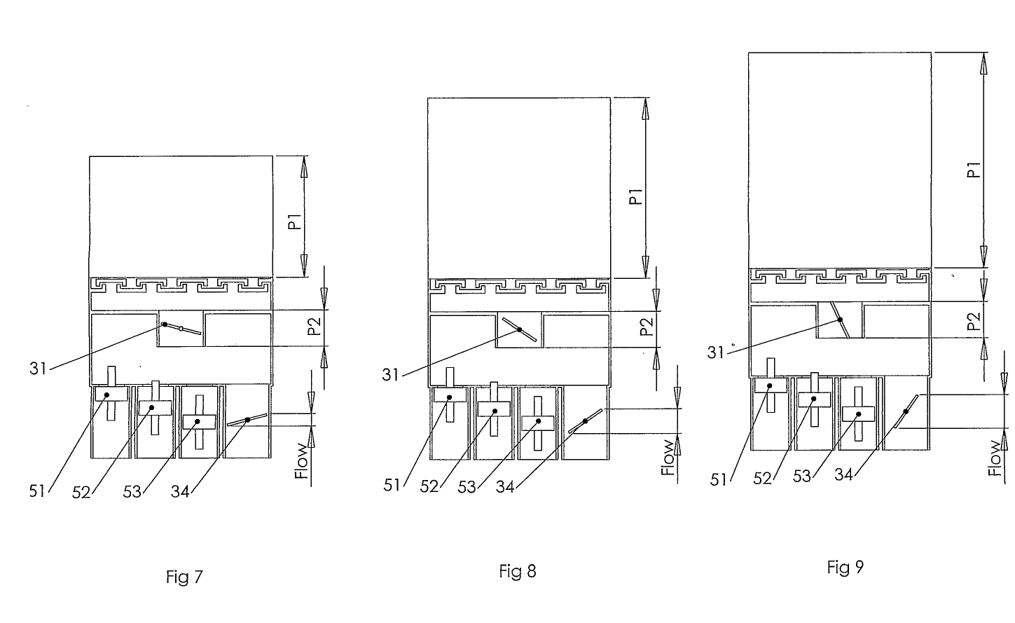

In FIG. 5 the underside of the air control device is illustrated where the aperture 21 may be adjusted by simply rotating the plate member 35 around the bolt 36 and fixing it by means of bolts 37. In this manner a fixed air flow cross sectional area is established where the cylinders 24, 25 and 38 provides for adjustments of the air flow as will be explained with reference to FIGS. 7, 8 and 9.

In FIG. 6 is depicted typical air flow characteristics for an air flow control devices according to the invention. “Delta pressure across unit” indicates the pressure increase relating to the flow rate. When the flow rate is substantially constant, i.e. for example in the interval 8-10 a homogenous cooling of the particular bed may be achieved. By using an air control devise as depicted in FIGS. 4 and 5 the size of the aperture 21 will determine the level, i.e. whether it is series 1, 2 or 3 flow rate which is to be achieved and the three cylinders 24, 25 and 38 incorporating float members will determine when the “sick-sack” 40, 41 and 42 occurs. The first sick-sack 40 corresponds to the largest cylinder whereas the sick-sack 42 corresponds to the smallest cylinder (effective flow area). Therefore by adjusting the air flow through the air flow control device for example by altering the size of the aperture 21, the air flow through the air flow control device may be adjusted such that at a normal situation, i.e. when the thickness of the layer of particular material on the bed is being cooled in the most optimal way, i.e. when the heat exchange is optimal the float represented by the sick-sack 41 is floating, i.e. suspended in the cylinder due to the influence of the air flow. Therefore if the particular bed should increase in thickness the other float member will open and in the opposite situation the float member will close. This is further illustrated with reference to FIGS. 7, 8, 9.

The combination of openings, i.e. the air flow decided by the float members 51, 52, 53 and the more or less closed apertures by the hood 31 and by the plate member 34 correspond to the series 3 in FIG. 6. FIG. 8 corresponds to series 2 and FIG. 9 corresponds to series 1. In this manner is clearly seen that by adjusting the size, i.e. the area of the aperture 21 by using the plate member 34 here depicted as a baffle, the general level of air flow through the air flow control device may be determined. By further regulating the baffle 34 it may be foreseen that the floats 51, 52, 53 will come into a situation where the float 51 is in the closed position, the float 52 is in an intermediate position just floating on the air steam and the float member 53 is in the bottom position. As the air flow rate increases as depicted in FIG. 6, the float 52 will be pushed upwards and eventually close the air going through the cylinder whereby the sick-sack formation 41 will occur as depicted in FIG. 6. Eventually the air flow through the air flow control device may further increase due to a thin particulate layer or due to a instant blow out, i.e. all particulate material has been blown away by the ventilation whereby the float member 53 will be pushed upwards and thereby cut off the air stream through the air flow control device.

Traditionally a cooler bed for cooling cement clinker down stream of a kiln will have substantially constant flow and thereby thickness of the clinker layer indicated by PI in FIGS. 7, 8 and 9. However, along the walls and as the clinker material is cooled the air pressure drop will as explained above be different in one position of the cooler in relation to other positions. For these purposes it is possible to adjust the air flow control devises and tests have indicated that by arranging one air flow control device in each square of 400×400 mm the ventilation conditions may be optimized such that the heat exchange of the cement clinker particulate material is optimum and the ventilation air may be used as pre-heated combustion air for heating the kiln. Typically the savings is approx. 10% on the electricity corresponding to 0.5 KWh per metric ton, and fuel savings of 100 to 250 KJ/kg depending on the technology level of the entire plant.

In a 20 years old installation, producing 5000 ton per day: 250 KCal/kg×5000 ton/day x1000 kg/ton=1.25×10⁹ KCal/day (oil having an energy capacity of 10000 Kcal/kg will correspond to a saving of 125 ton oil per day) and electrical savings 2500 kWh/day

A further advantage is hereby the fact that the CO₂ emission will be lowered in that the preheated air does not need to be heated by fossile fuels as the heat exchange through the cooler bed increases the temperature of the preheated air for the kiln.

1. Airflow control device, for controlling the airflow through a bed of particulate material where said device comprises a base plate suitable for being mounted in a floor, wall, ceiling or other partition, where the base plate has a front side adapted to be arranged towards the material to which the airflow is directed, and a back side opposite the front side, and that in said base plate, two or more apertures are provided, where at least one aperture is in the shape of a cylinder having the cylindrical axis not parallel to the plane of the base plate, and that inside said cylinder radial restriction means are arranged adjacent both open ends of the cylinder, and that a float member is provided between said radial restrictors, where when the float member is in contact with the upper radial restrictor arranged adjacent the front side of the base plate, flow through the cylinder is cut off and further that a hood is provided-covering a substantial part of the front side of the base plate, where said hood is pivotably connected to the base plate, such that an adjustable gap is provided between the front side of the base plate and the rim of the hood.

2. Airflow control device according to claim 1, wherein two or three cylinders are provided, where they all have either different effective cross-sectional flow areas, or where the weight of the float members are different, such that the flow through the airflow control device, will cause one or more float members to engage the upper radial restrictors.

3. Airflow control device according to claim 1, where one aperture is not provided with float members, and that the cross-sectional area of this aperture may be varied.

4. Air flow control device according to claim 1 wherein each cylinder having a float member, has a cross-sectional area corresponding to 15% or less, more preferred 10% or less of the entire air flow area of the device.

5. (canceled)

6. Air flow control device according to claim 1, wherein a baffle incorporated in a cover plate is provided covering a substantial part of the front side of the base plate, where said baffle is operated to adjust the air flow through the air flow control device.

7. A method for cooling a bed of particulate material, where the particulate material is supported by an air distribution floor, where cooling air is supplied to one or more compartments below the distribution floor, and that airflow control devices according to any of claim 1 are arranged in said air distribution floor such that a regulated and controlled flow of cooling air is forced up through the particulate material layer by means of the air flow control devices arranged in the distribution floor.

8. A method according to claim 6 wherein the particulate material is cement clinker, and that the bed of material to be cooled is downstream from a rotary kiln, where the distribution floor is divided into sections, each section being approximately 400×400 mm and that in each section one airflow control device is provided, where each airflow device is pre-adjusted by regulating the cross sectional area of the aperture not having a float member and/or by adjusting the gap between the hood and the base plate.
